(19) United States
(12) Patent Application Publication
(10) Pub. No.: US 2009/0000590 A1
(43) Pub. Date: Jan. 1, 2009

(54) Internal Combustion Engine with an Improved Charging Action in the Combustion Chamber

(75) Inventors: Ronald Buhr, Mainz (DE); Jan Zimmermann, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/158,688

(22) PCT Filed: Dec. 18, 2006
(86) PCT No.: PCT/EP2006/012190

§ 371 Date: Jun. 20, 2008

(30) Foreign Application Priority Data
Dec. 22, 2005 (DE) 10 2005 061 446.9

(51) Int. Cl. F02F 1/42

(52) U.S. Cl. 123/193.5; 123/306

(57) ABSTRACT

A cylinder head arrangement is provided for an internal combustion engine of a motor vehicle. The cylinder head arrangement includes, but is not limited to a combustion chamber, a first intake valve in a first intake port, as well as a first exhaust valve in a first exhaust port and a second exhaust valve in a second exhaust port (19). The second exhaust port is realized in such a way that a gas flow from the second exhaust port back into the combustion chamber results in an at least partially swirling flow in the combustion chamber.

### CROSS-REFERENCE TO RELATED APPLICATIONS

This application is a U.S. National-Stage entry under 35 U.S.C. § 371 based on International Application No. PCT/EP2006/012190, filed Dec. 18, 2006, which was published under PCT Article 21(2) and which claims priority to German Application No. DE102005061446.9, filed Dec. 22, 2005, which are all hereby incorporated in their entirety by reference.

### TECHNICAL FIELD

The invention pertains to an internal combustion engine for a motor vehicle.

### BACKGROUND

According to the state of the art, the ignition and combustion behavior of an internal combustion engine can be improved by introducing the supplied combustion gases into a combustion chamber in a cylinder head such that a desired layering is achieved therein. U.S. Pat. No. 4,494,504 describes an internal combustion engine with four valves per cylinder, in which the fuel/air mixture in the combustion chamber is situated near the spark plug before the ignition takes place. To this end, U.S. Pat. No. 4,762,102 proposes to respectively arrange a partition wall or a masking in one of the intake ports in order to deflect the combustion gases flowing into the combustion chamber in such a way that an intense vortex motion is created in the combustion chamber.

EP 0 537 745 A1 describes an intake system for an internal combustion engine, in which the inflowing combustion gas transforms from a tumbling flow into a turbulent flow.

In view of the foregoing, the methods for operating an internal combustion engine known from the state of the art are in need of improvement in order to lower the fuel consumption and the pollutant emission. Therefore, at least one objective is to make available an internal combustion that is improved in this respect, as well as a method for its operation and a motor vehicle equipped with such an internal combustion engine. In addition, other objectives, desirable features, and characteristics will become apparent from the subsequent summary, detailed description, and the appended claims, taken in conjunction with the accompanying drawings and this background.

### SUMMARY

The at least one objective, other objectives, desirable features, and characteristics are attained with an internal combustion engine of a motor vehicle with a cylinder head arrangement. The cylinder head arrangement features a combustion chamber and in the combustion chamber a first intake valve in a first intake valve seat of a first intake port as well as a first exhaust valve in a first exhaust valve seat of a first exhaust port. In addition, a second exhaust valve is provided in a second exhaust valve seat of a second exhaust port. The first exhaust port and/or the second exhaust port are realized in such a way that a gas flow from the first exhaust port back into the combustion chamber or a gas flow from the second exhaust port back into the combustion chamber results in an at least partially swirling flow in the combustion chamber. Furthermore at least one first masking elevation is provided in the first exhaust port in the region of the first exhaust valve seat and/or at least one second masking elevation is provided in the second exhaust port in the region of the second exhaust valve seat. The walls of the first masking elevation and/or the second masking elevation are realized in such a way that gas flows from the first exhaust port back into the combustion chamber or from the second exhaust port back into the combustion chamber which flow along these walls are deflected away from the center axis of the combustion chamber and toward the side wall of the combustion chamber when, after discharging combustion gas from one or more exhaust ports of the combustion chamber, exhaust gas is taken in into the combustion chamber from one or more exhaust ports at the same time fresh fuel/air mixture is taken in through one or more intake ports of the combustion chamber such that a layering is created in the combustion chamber, in which the not yet combusted fuel/air mixture is situated in the interior of the combustion chamber and the already combusted combustion gas accumulates around this region.

An exemplary embodiment of the internal combustion engine has a cylinder head arrangement with usually four valves per cylinder. Two of these valves are realized in the form of intake valves and the two other valves are realized in the form of exhaust valves. One respective valve seat ensures a reliable seal between the combustion chamber of each cylinder and the assigned intake and exhaust ports. In the inventive internal combustion engine, the first exhaust port or a second exhaust port is realized in such a way that a gas flow from the exhaust port back into the combustion chamber results in an at least partially swirling flow in the combustion chamber.

In this context, the term at least partially swirling flow in the combustion chamber refers to a flow of the combustion gases that takes place in a vortex-shaped fashion around the center axis of the combustion chamber, in which the spark plug electrode is arranged. In this case, the gas flows into the combustion chamber about tangentially such that it is circularly deflected on the cylindrical side walls of the combustion chamber in a top view of the combustion chamber.

According to an exemplary embodiment of the invention, the combustion in the internal combustion engine is improved in that, after discharging the combustion gases, a portion of these combustion gases is taken in into the combustion chamber together with fresh fuel/air mixture. This can be achieved, for example, with a larger valve overlap and realized with a camshaft adjustment or an electric or hydraulic valve control. The skillful control of the flow direction of the combustion gases that are thusly taken back in into the combustion chamber makes it possible to create a desired layering of the fresh fuel/air mixture as combustion gas in the combustion chamber.

According to an exemplary embodiment of the invention, the flow is introduced into the combustion chamber in such a way that a spiral-shaped flow of the combustion gases being taken back in is created therein. The gases flow along at least a section of the outer wall of the combustion chamber without creating significant turbulences in this region. The gases flow along a partially circular path in this case.

A person skilled in the pertinent art knows how ports in a cylinder head need to be designed in order to subject the gas flow extending through such a port to a desired change in direction or deflection in the interior of the combustion chamber. To this end, the science from the field of generating turbulent gas flows or tumbling gas flows in the region of the intake ports of a cylinder head can, with consideration of the revised boundary conditions according to the invention, be applied to a gas flow that results from combustion gases being taken back in into the combustion chamber from an exhaust port. According to an exemplary embodiment of the invention, it needs to be taken into account that the gas flow taken back in into the combustion chamber is significantly smaller and represents a smaller quantity than that of the gas flow at the intake port of a cylinder head.

Naturally, the exemplary embodiments of the invention can also be used in connection with internal combustion engines with three valves or even only two valves, only one of which forms an exhaust valve.

In the region of the exhaust valve seat or the two participating exhaust valve seats, respectively, at least one masking elevation in the form of an integrally cast bulge may be provided in the respective exhaust port. Such a wall deflects exhaust gas flows, for example, as described with respect to an intake port in U.S. Pat. No. 4,6762,102. In this case, the walls of the masking elevation are designed in such a way that gas flows from the exhaust port back into the combustion chamber which flow along these walls are deflected away from the center axis of the combustion chamber and toward the side wall of the combustion chamber. Such a design makes it possible to produce spiral-shaped gas flows in a particularly simple fashion.

According to an exemplary embodiment of the invention, the intake port may also be provided with a design that results in an at least partially swirling flow of fresh combustion gases into the combustion chamber. In this case, such a design may be provided on one or even on both of a total of two intake valves or intake ports, respectively.

According to an exemplary embodiment of the invention, a combination of intake ports and exhaust ports, in which at least partially swirling flows respectively result in the combustion chamber when combustion gas is taken in, may be operated as described below. It is initially possible to realize an internal combustion engine in such a way that the fresh combustion gases in the intake port or in the two intake ports which flow into the combustion chamber, as well as the used combustion gases that flow into the combustion chamber as a result of being taken back in from the exhaust ports, respectively produce an identically directed vortex. In this case, the relatively small gas flow from the exhaust port into the combustion chamber boosts the comparatively powerful gas flow from the intake port such that a vortex is produced around the center axis of the combustion chamber. In this case, it is possible to adjust the gas flows such that the not yet combusted fuel/air mixture is situated in the interior of the combustion chamber at the location of the spark plug electrode. The already combusted combustion gas accumulating around this region then forms an insulation for the subsequent combustion of the fresh fuel/air mixture. This makes it possible to achieve a reduction of nitrogen oxides in the exhaust gas, as well as an improved efficiency.

Contrary to this design, it would also be possible that the used combustion gases flowing into the combustion chamber impact on the fresh combustion gases flowing into the combustion chamber in the form of a fuel/air mixture in such a way that a turbulent or a tumbling flow is created. This makes it possible to realize certain other effects by influencing the combustion of the fresh fuel/air mixture accordingly.

In four-valve engines, the two above-described principles may also be combined in that the two gas flows that lie diagonally opposite referred to the center axis of the combustion chamber respectively produce a swirling flow in the same direction while the two other gas flows produce a tumbling flow.

The exemplary embodiment of invention is also realized in a motor vehicle, in which such an internal combustion engine with an inventive cylinder head is used. The inventive method comprises the individual above-described steps. In order to simplify the description, the term “combustion gas” was used for the mixture of fuel and combustion air, as well as for the products created during the combustion.

The exemplary embodiment of the invention reduces the fuel consumption of the concerned internal combustion engines and increases the compatibility with recycled exhaust gas. The exemplary embodiment of the invention provides an increased charge motion. The exemplary embodiment of the invention utilizes the exhaust ports for producing an additional charge motion. In this case, a masking and shaping of the outlet ports in the above-described fashion is utilized.

The exemplary embodiment of the invention makes it possible to influence the flow in the intake ports, wherein an impairment of the filling of the combustion chamber in dependence on the respective operating state is prevented. This is advantageous, in particular, for operating states, in which no increased charge motion is required. Such an increased charge motion is desirable, in particular, for increasing the combustion stability when recycled exhaust gas is supplied.

According to the exemplary embodiment of the invention, the exhaust gas recycling is at least partially realized with a retarded exhaust camshaft such that exhaust gas is taken back in into the combustion chamber from the exhaust manifold by the descending piston.

Due to the shaping of the exhaust ports, the invention utilizes this backflow of exhaust gases for increasing the charge motion. Particularly in engines with camshaft adjustments and retarded exhaust closing, i.e., with a backflow from the exhaust port, the charge motion can be additionally increased with the proposed inventive combination of the exhaust ports and, if applicable, an additional masking in the form of walls or bulges in the exhaust ports.

In the exhaust gas recycling achieved by means of a retarded exhaust adjustment, the exhaust gas flows over the exhaust valves at a slight valve lift. If a masking or an elevation or bulge, particularly in the form of an elevated casting on the cylinder head, is arranged on one of the exhaust valves, for example, on the valve disk, or in the region of the exhaust valves, for example, in the exhaust port, the discharge on the valve underside is impaired such that a greater mass flow is discharged over the upper side of the valve. This results in a swirling charge motion that boosts the existing intake swirl if the shielding or masking is chosen correctly.

In this respect, the exemplary embodiment of invention also pertains, in particular, to the combination of masking and purposefully shaping the exhaust ports.

An exhaust port masked in order to produce a swirl is provided with a port contour that additionally promotes swirling of the combustion gases. The shape of the intake ports for producing a swirling combustion gas flow can be applied analogously to the exhaust ports.

The masking of both exhaust ports makes it possible to produce a tumbling motion of the combustion gas being taken back in, wherein this tumbling motion is then directed opposite to a tumbling intake flow.

The exemplary embodiment of the invention makes it possible to increase the charge motion in the cylinder of an internal combustion engine with simple means. The compatibility with recycled exhaust gas is improved. The fuel consumption can be lowered due to the thusly possible de-throttling.

Due to the shaping of the exhaust ports and, if applicable, an additional masking, the exemplary embodiment of the invention utilizes the backflow of exhaust gas for realizing or intensifying the charge motion. The exemplary embodiment of the invention can be implemented by changing the casting moulds for the exhaust ports and, if applicable, for the combustion chamber.

According to the exemplary embodiment of the invention, both exhaust ports and the intake ports may be divided into a swirling port and a filling port. In this case, the swirling port is curved toward the cylinder wall and, if applicable, realized such that a large portion of the charge is discharged over the upper side of the valve. To this end, the port extends into the combustion chamber at a slightly shallower angle. Such a characteristic is also realized or promoted with a masking on the underside of the valve. The swirling port is designed in a correspondingly opposite fashion, i.e., it is aligned straight to the center of the combustion chamber and, if applicable, extends into the combustion chamber at a slightly steeper angle than the filling port.

A number of sensible applications result for the variation, in which the masking of both exhaust ports causes the combustion gases being taken back in to produce a tumbling motion of the concerned gas flows that are directed opposite to the tumbling intake flow. Particularly in instances, in which a reversed tumbling motion or “Reverse Tumble” is used as it is the case with certain diesel engines, the tumbling state promoted by the masking can be produced by the backflow of the charge. This tumbling state then promotes the tumbling motion of the intake flow. It would also be possible to realize a reversed arrangement with a tumbling motion on the intake side and a “Reverse Tumble” or reversed tumbling motion on the exhaust side.

### BRIEF DESCRIPTION OF THE DRAWINGS

The exemplary embodiment of the invention will hereinafter be described in conjunction with the following drawing figures, wherein like numerals denote like elements, and

FIG. 1 shows a cross section through an inventive cylinder head in the region of one cylinder of an internal combustion engine, and

FIG. 2 shows another cross section through the cylinder head according to FIG. 1.

### DETAILED DESCRIPTION

The following detailed description is merely exemplary in nature and is not intended to limit application and uses. Furthermore, there is no intention to be bound by any theory presented in the preceding background and summary or the following detailed description.

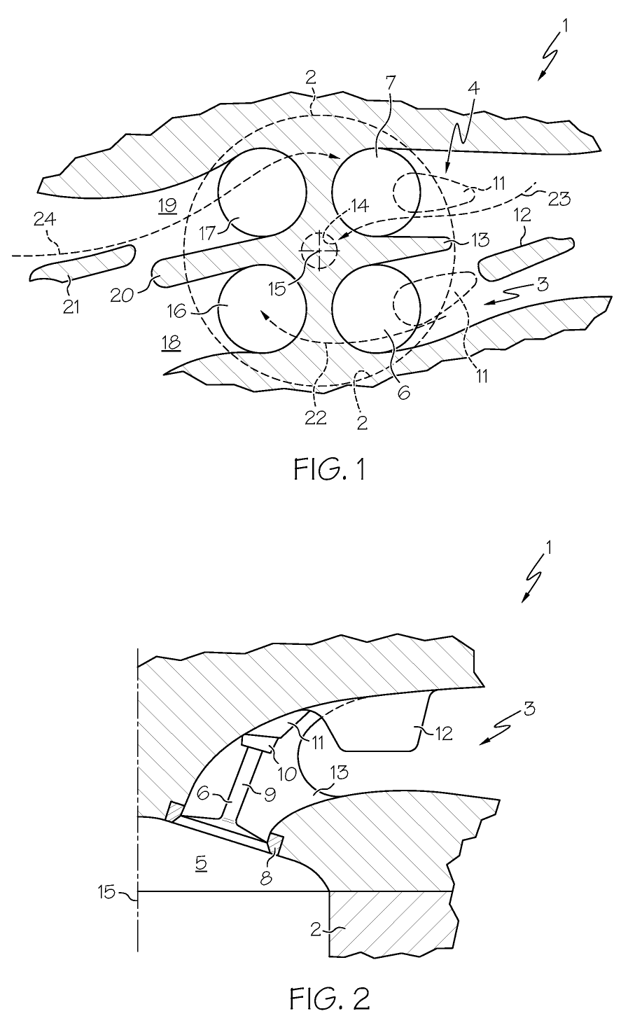

FIG. 1 and FIG. 2 show cross sections through an inventive cylinder head 1 of an otherwise not-shown internal combustion engine. The cross sections extend through the region of the cylinder 2 that is illustrated in the form of a circular broken line in FIG. 1.

The cylinder head 2 features a first intake port 3 and a second intake port 4 that are closed in the region of the combustion chamber 5 by a first intake valve 6 and a second intake valve 7. Valve seats 8 are provided in order to produce a better seal, wherein only the valve seat of the first intake valve 6 is illustrated in FIG. 2. On the upper side, the valve stems 9 of the first intake valve 6 and the second intake valve 7 are respectively guided by a valve stem guide 10. The valve stem guides 10 are respectively guided in a valve stem guide receptacle 11 in the cylinder head 1 in this case. In the region of the first intake port 3, a masking elevation 12 is provided that is realized in the form of a projection that protrudes downward from the upper side of the first intake port 3. A center wall 13 separates the first intake port 3 from the second intake port 4.

The cylinder head 1 furthermore features a spark plug opening 14 that is illustrated with a broken line in FIG. 1. In this case, the spark plug opening 14 coincides with the center line 15 of the cylinder 2 and of the combustion chamber 5.

Similarly to the first intake valve 6 and the second intake valve 7, a first exhaust valve 16 and a second exhaust valve 17 are provided in the cylinder head 1. These valves are illustrated in FIG. 1. The first exhaust valve 16 separates a first exhaust port 18 from the combustion chamber 5. Analogously, the second exhaust valve 17 separates the second exhaust port 19 from the combustion chamber 5. A center wall 20 also separates the first exhaust port 18 from the second exhaust port 19 in this case. The second exhaust port 19 features an integral masking elevation 21 in the form of a bulge that protrudes downward from the top in the second exhaust port 19.

During the operation, the inventive cylinder head 1 functions as described below. After the combustion stroke, the combustion gas situated in the interior of the combustion chamber 5 is discharged into the first exhaust port 18 and into the second exhaust port 19 through the first exhaust valve 16 and the second exhaust valve 17. Subsequently, the intake stroke begins, during which the piston moves downward in the cylinder 2 from its position in the top dead center while the first intake valve and the second intake valve are open. This causes fresh fuel/air mixture to flow into the combustion chamber 5. Due to the special design of the first intake port 3 and due to the masking elevation 12, the combustion gas flow in the first intake port 3 extends as indicated with the motion arrow 22. The combustion gas flow 22 flows through the first intake valve 6 and in a spiral-shaped fashion along the circumference of the cylinder 2 in the interior of the combustion chamber 5 as illustrated in FIG. 1. This means that a layered charge of fresh combustion gas is made available in the combustion chamber 5. Fresh combustion gas in the second intake port 4 simultaneously flows into the region of the spark plug opening 14 through the second intake valve 7 as indicated by the motion arrow 23. This combustion gas flow 23 is introduced into the combustion chamber 5 at a steeper angle than the combustion gas flow 22.

In this internal combustion engine, the second exhaust valve 17 is slightly opened at the beginning of the intake stroke. This is achieved with a not-shown camshaft adjusting device. The first exhaust valve 16 remains completely closed during the entire intake stroke. Used exhaust gas is taken back in into the combustion chamber 5 from the exhaust port through the slightly opened second exhaust valve 17. This is indicated with the motion arrow 24. The combustion gas flow 24 taken in from the exhaust manifold flows along a path in the interior of the combustion chamber 5 that is similar to the path of the combustion gas flow 22, namely along the circumference of the cylinder 2 and in a spiral-shaped direction. The accumulation of the combustion gas flow 23 in the region of the spark plug opening 14 is favorably affected by the combustion gas flow 22. The layering is thusly achieved in the combustion chamber 5.

In another not-shown embodiment, the first exhaust valve 16 is also opened during the intake stroke such that exhaust gases flow back into the combustion chamber 5 from the first exhaust port 18.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1-12. (canceled)

13. A cylinder head for an internal combustion engine of a motor vehicle, comprising:
a combustion chamber;
a first intake valve in a first intake valve seat of a first intake port in said combustion chamber;
a first exhaust valve in a first exhaust valve seat of a first exhaust port in said combustion chamber; and
a second exhaust valve in a second exhaust valve seat of a second exhaust port in said combustion chamber,
wherein at least one of the first exhaust port and the second exhaust port are adapted to provide at least one of a gas flow from the first exhaust port back into the combustion chamber and a gas flow from the second exhaust port back into the combustion chamber that results in an at least partially swirling flow in the combustion chamber,
wherein at least one of a first masking elevation is provided in the first exhaust port in a region of the first exhaust valve seat and a second masking elevation is provided in the second exhaust port in a region of the second exhaust valve seat,
wherein at least one of the walls of the first masking elevation and the second masking elevation are adapted in such a way that gas flows from at least one of the first exhaust port back into the combustion chamber and from the second exhaust port back into the combustion chamber which flow along these walls are deflected away from a center axis of the combustion chamber and toward a side wall of the combustion chamber
wherein after discharging combustion gas from at least one of the exhaust ports of the combustion chamber, exhaust gas is taken in into the combustion chamber from at least one the exhaust ports while a fresh fuel/air mixture is taken in through at least of the intake ports of the combustion chamber, and
wherein a layering is created in the combustion chamber in which an uncombusted fuel/air mixture is situated in an interior of the combustion chamber and combusted combustion gas accumulates around this region.

14. The cylinder head according to claim 1, wherein the first intake port is adapted such that a gas flow from the first intake port into the combustion chamber results in an at least partially swirling flow in the combustion chamber.

15. The cylinder head according to claim 1, further comprising a second intake valve in a second intake valve seat of a second intake port.

16. The cylinder head according to claim 1, wherein at least one of the two intake ports is adapted such that a gas flow from the at least one of the two intake ports into the combustion chamber results in an at least partially swirling flow in the combustion chamber, and in that the exhaust port situated diagonally opposite to the center axis of the combustion chamber is realized in such a way that a gas flow from this exhaust port back into the combustion chamber results in an at least partially swirling flow in the combustion chamber.
